(19) United States
(12) Patent Application Publication
(10) Pub. No.: US 2024/0271871 A1
(43) Pub. Date: Aug. 15, 2024

(54) MONITORING A FLAME TREATMENT DEVICE

(71) Applicant: SINGULUS TECHNOLOGIES AG, Kahl am Main (DE)

(72) Inventors: Giani BRECHTL, Freigericht (DE); Edgar RÜTH, Kahl am Main (DE); Felix RÜBSAM, Bad Orb (DE); Kathrin HÖPFNER, Schaafheim (DE)

(21) Appl. No.: 18/289,737

(22) PCT Filed: Mar. 3, 2022
(86) PCT No.: PCT/EP2022/055475

§ 371 Date: Nov. 6, 2023

(30) Foreign Application Priority Data
May 7, 2021 (DE) 10 2021 002 449.4

(51) Int. Cl. F27B 9/40; A62C 37/36; F27D 21/00

(52) U.S. Cl. CPC F27B 9/40; A62C 37/04; F27D 21/0014; F27D 2021/0057

(57) ABSTRACT

The present invention relates very generally to the monitoring of a flame treatment device and in particular to a substrate treatment system having a flame treatment device and first and second substrate monitoring units.

The present invention relates in general to the monitoring of a flame treatment device and in particular to a substrate treatment system having a flame treatment device and first and second substrate monitoring units.

Flame treatment, during which the surface of a substrate is exposed to a gas flame that is operated with excess oxygen for a defined process time, can be used in different industrial processes. Thus, it is for example possible to improve adhesion on polyolefin substrates using a gas flame (the so-called Kreidl method). In industrial processes, the substrates are as a rule automatically exposed to the flame for a few seconds. However, if the process time is not adhered to or a wrong process time is selected, overheating may occur and in the case of combustible substrates, e.g., plastic substrates, ignition of the substrate may occur, which involves the risk of fire in the corresponding system.

Thus, one of the problems underlying the present invention is to provide a monitoring mechanism which reliably prevents the occurrence of a fire without the process being stopped or having to be stopped more often than necessary. This problem is solved by a substrate treatment system according to claim 1 and a method of flame treatment of substrates according to claim 14.

The present invention is substantially based on the concept of providing two substrate monitoring units which monitor different process parameters so as to prevent the occurrence of fire effectively and efficiently and with low susceptibility to interference.

The substrate treatment system of the invention comprises a flame treatment device for flame treating substrates in a flame zone. The flame treatment device may be any flame treatment device known from the prior art. The substrate treatment system further comprises a transport device for transporting a substrate carrier with substrates through the flame treatment system. The transport device may comprise one or more transport units for transporting the substrate carrier. For example, a first transport unit can be provided for transporting the substrate carrier through the flame zone and a second transport unit can be provided for transporting the substrate carrier onward after it passes the flame zone. The transport device may also comprise further transport units for transporting the substrate carrier to the flame treatment device.

The invention provides a first substrate monitoring unit that is suited and configured to monitor the movement of the substrate carrier through the flame treatment device with respect to its transport speed and/or its dwell time in the flame zone. Furthermore, the invention provides a second substrate monitoring unit that is suited and configured to monitor the substrates in the substrate carrier with respect to their temperature after they exit the flame zone. The substrate treatment system further comprises a control unit that is suited and configured to switch off the flame treatment device and in particular its flame if the first substrate monitoring unit detects a transport speed of a substrate carrier which is too low or a dwell time of a substrate carrier which is too long in the flame zone. The control unit is further suited and configured to stop the transport of the substrate carriers through the flame treatment device and, in particular through the flame zone, in case the second substrate monitoring unit detects a temperature of a substrate which is too high.

Due to this dual monitoring, a number of advantages are achieved. The first substrate monitoring unit allows for both simple and reliable monitoring and, as a rule, will prevent that substrates are heated for too long a time period or overheated in the first place since the flame is switched off before it can act on the substrates in the substrate carrier for too long. However, since ignition might occur nonetheless (for example, due to incorrect loading with substrates having a lower ignition point), the second substrate monitoring unit is to ensure that substrates showing too high a temperature are identified in any case and that their further transport to sensitive areas of the substrate treatment system (for example, downstream treatment units for paint spraying) is reliably prevented. In principle, a substrate treatment system having only the second substrate monitoring unit would be functional. However, it would have the disadvantage that fire would occur more frequently, which would have an adverse effect on the continuous operation of the substrate treatment system due to the ensuing consequences (triggering a fire extinguishing process etc.). The short-term shut-down of the flame treatment device initiated by the first substrate monitoring unit is clearly less problematic in this respect, however, it can prevent the occurrence of fire in up to 99 percent of cases, if necessary. Against this background, the combination of first and second substrate monitoring units is particularly reliable and efficient and at the same time it minimizes interference with the process to the maximum possible extent.

The first substrate monitoring unit preferably comprises at least two, more preferably at least three sensors which are suited and configured to detect the presence of a substrate carrier at at least two, preferably at least three positions in the flame treatment device. Since during regular operation, it may be assumed that the substrate carriers move at a constant speed, it is as a rule sufficient to know the points in time when the substrate carrier enters the flame zone and when it exits the flame zones in order to determine the transport speed with which the substrate carrier was moved through the flame zone. If the substrate carrier is not detected at the end of the flame zone after the normal dwell time or after a predetermined threshold time, the flame is switched off in order to avoid further heating of the substrates in the substrate carrier. In view of a system that is as redundant as possible, it is preferred to use at least three sensors. Sensors that are suited for this purpose are for example photoelectric sensors and photoelectric barriers, e.g., photoelectric proximity sensors and photoelectric barriers of model series G2S (e.g., GTB2S-F5311) or W2S-2 (GTB2S-F5311) produced by Sick AG.

The second substrate monitoring unit preferably comprises at least one, more preferably at least two temperature measuring unit(s). This unit/These units is/are preferably suited to measure the temperature of the substrates after they exit the flame zone with an accuracy of +/−10° kelvin. The measuring should preferably take place within the time period in which the substrates move past the relevant temperature measuring unit, i.e., as a rule within a few seconds, so that, preferably, fast-responding temperature measuring units such as pyrometers can be used.

The stopping of the transport of the substrate carriers by the flame treatment device is preferably controlled in such a way that the substrate having too high a temperature (or the substrate carrier containing said substrate) is stopped in a defined area of the substrate treatment system. On the one hand, this defined area has to be located in a part of the substrate treatment system where a possibly burning substrate can cause minimal damage, for example in a fireproof environment. On the other hand, it is preferred that the substrate treatment system further comprises a flame detector that is suited to detect a flame specifically in said defined area. Said flame detector can for example be an approved fire detector and/or an approved fire monitoring system. This additional flame detector is advantageous in that, as explained above, the second substrate monitoring unit must carry out a temperature measurement in relatively short time, which may be susceptible to errors. However, before a fire extinguishing process is initiated, for example, there should be reasonable certainty that an actual fire hazard is given or that a substrate has already caught fire. This can be achieved with the additional flame detector which precisely detects the presence of a flame in the defined area in which the substrate carrier was stopped. However, said flame detector serves only as an additional and preferably officially approved safety device which is only activated if the second substrate monitoring unit has previously detected that the temperature of a substrate is too high.

The control unit is further preferably suited and configured to request a manual fire extinguishing process and/or to initiate an automatic fire extinguishing process if the flame detector detects a flame in the defined area. For example, an acoustic or optical fire alarm can be activated and/or a fire-extinguishing system (e.g., a sprinkler unit, a carbon dioxide (CO2) fire suppression system, an inert gas fire suppression system) can be activated by the control unit.

As already mentioned, the transport device can comprise a first transport unit for transporting the substrate carrier at a first speed through flame treatment device and a second transport unit for transporting the substrates onward at a second speed after they pass the flame treatment device or its flame zone, wherein the first and the second speed may differ from one another.

Thereby a substrate carrier can be stopped after it exits the flame treatment device (for example, in the defined area to detect a flame) without having to interrupt the further loading of the flame treatment device since different transport units are provided for this purpose. In this case, the control unit is particularly suited and configured to stop the second transport unit of the transport device if the second substrate monitoring unit detects that the temperature of a substrate is too high.

The control unit is further suited and configured to switch off the flame treatment device if the second substrate monitoring device detects that the temperature of a substrate is too high. It is further preferred that the control unit is suited and configured to stop the loading of the flame treatment device if the second substrate monitoring unit detects that the temperature of a substrate is too high. Stopping the substrate carriers takes place in such a way that the flame treatment device is actually unloaded before the substrate carriers are stopped.

The present invention can in principle be used in any substrate treatment system which requires a flame treatment device. For example, the substrate treatment system can further comprise one or more of the following units: a paint spraying device, a cleaning device, in particular a brush cleaning device, a coating device, in particular a PVD or CVD coating device, a bonding device, a printing device.

The present invention is further directed to a method of flame treating substrates by means of the above-discussed substrate treatment system, wherein the method comprises the following steps: continuous transport of a number of substrate carriers through the flame treatment device, wherein the substrates of each substrate carrier in the flame treatment device are flame-treated; monitoring the substrate carriers with respect to their transport speed and/or their dwell time in the flame zone in the flame treatment device; monitoring the substrates after they exit the flame zone with respect to their temperature; switching off the flame treatment device if it is detected that the transport speed is too low and/or the dwell time is too long in the flame zone; and stopping the substrate carrier if it is detected that the temperature of a substrate is too high after it exits the flame zone. Preferably, the flame is measured in a defined area, in which a substrate showing too high a temperature is stopped. If a flame is detected, preferably a manual fire extinguishing process is requested and/or an automatic fire extinguishing process is initiated. If it is detected that the temperature of a substrate is too high after the substrate exits the flame zone, the flame treatment device and, in particular its flame are switched off. If it is detected that the temperature of a substrate is too high after the substrate exits the flame zone, it is further preferred that the loading of the flame treatment device is stopped. Stopping the substrate carrier preferably takes place in such a way that the flame treatment device is actually unloaded before the substrate carriers are stopped. The substrates preferably comprise plastic, particularly preferably polyolefin.

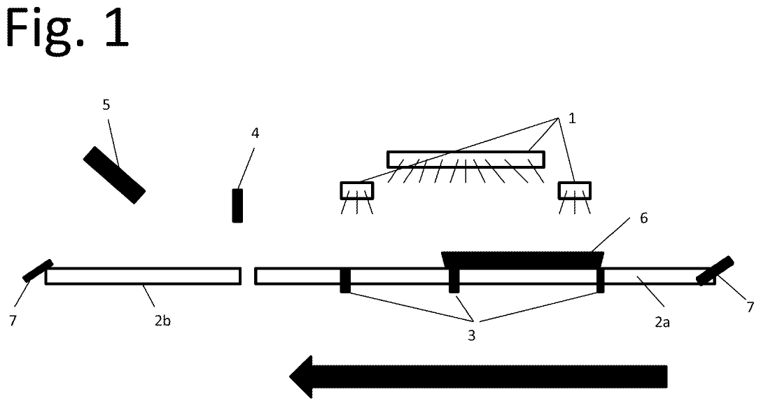

In the following, a particularly preferred embodiment of the present invention is described in greater detail based on FIG. 1.

FIG. 1 is a schematical illustration of a substrate treatment system with a flame treatment device 1 for flame treating substrates, which comprises a flame zone. The substrates present in a substrate carrier 6 are transported through the flame treatment device 1 by means of a transport device. In the embodiment shown, the transport device comprises a first transport unit 2a and a second transport unit 2b whose direction of movement is indicated by the arrow. Further provided is a first substrate monitoring unit 3 which is suited to monitor the movement of the substrate carrier 6 through the flame treatment device 1 with respect to its transport speed and/or its dwell time in the flame zone. In the embodiment shown, the first substrate monitoring unit 3 comprises three sensors which are suited to detect the presence of the substrate carrier 6 at three positions in the flame treatment device. Downstream of the flame zone of the flame treatment device, a substrate monitoring unit 4 is provided which is suited to monitor the substrates in the substrate carrier 6 with respect to their temperature after it exits the flame zone. If the second substrate monitoring unit 4, which, in the embodiment shown, comprises a temperature measuring unit, detects that the temperature of a substrate is too high, the transport of the substrate carriers through the flame treatment device 1 is stopped. In the embodiment shown, this is done by stopping the second transport unit 2b while the first transport unit 2a of the transport device can in principle continue to operate so that the flame treatment does not yet have to be interrupted. Stopping the substrate carrier 6 on the second transport unit 2b is controlled in such a way that the substrate showing too high a temperature or the substrate carrier containing said substrate is stopped in a defined area of the substrate treatment system, so that a flame in this defined area can be detected by means of the flame detector 5. If the flame detector 5 does not detect a flame, the operation of the second transport unit 2b can be resumed. Otherwise, appropriate measures are initiated, for example, a manual fire extinguishing process is requested or an automatic fire extinguishing process is initiated.

Stoppers 7 are provided at the front end of the first transport unit 2a as well as at the rear end of the second transport unit 2b, respectively.

1. A substrate treatment system comprising:
a flame treatment device for flame treating substrates, comprising a flame zone;
a transport device for transporting a substrate carrier with substrates through the flame treatment device;
a first substrate monitoring unit, which is suited to monitor the movement of the substrate carrier through the flame treatment device with respect to its transport speed and/or its dwell time in the flame zone;
a second substrate monitoring unit, which is suited to monitor the substrates in the substrate carrier with respect to their temperature after they exit the flame zone; and
a control unit,
which is suited to switch off the flame treatment device when the first substrate monitoring unit detects too low a transport speed and/or too long a dwell time of a substrate carrier in the flame zone, and
which is suited to stop the transport of the substrate carriers through the flame treatment device when the second substrate monitoring unit detects that the temperature of a substrate is too high.

2. The substrate treatment system of claim 1, wherein the first substrate monitoring unit comprises at least two sensors, which are suited to detect the presence of a substrate carrier at least two positions in the flame treatment device.

3. The substrate treatment system of claim 1, wherein
the second substrate monitoring unit comprises at least one temperature measuring unit.

4. The substrate treatment system of claim 3, wherein the temperature measuring unit is suited to measure the temperature of the substrates after they exit the flame zone.

5. The substrate treatment system of claim 1, wherein stopping the substrate carriers is controlled in such a way that the substrate showing too high a temperature is stopped within a defined area of the substrate treatment system.

6. The substrate treatment system of claim 5, wherein the substrate treatment system further comprises a flame detector which is suited to detect a flame in the defined area.

7. The substrate treatment system of claim 6, wherein the flame detector comprises an approved fire detector and/or an approved fire monitoring system.

8. The substrate treatment system of claim 6, wherein the control unit is suited to request a manual fire extinguishing process and/or to initiate an automatic fire extinguishing process when the flame detector detects a flame in the defined area.

9. The substrate treatment system of claim 1, wherein the transport device comprises a first transport unit for transporting the substrate carriers at a first speed through the flame zone and a second transport unit for transporting the substrate carriers onward at a second speed after they pass the flame zone.

10. The substrate treatment system of claim 1, wherein the control unit is further suited to switch off the flame treatment device when the second substrate monitoring unit detects that the temperature of a substrate is too high.

11. The substrate treatment system of claim 1, wherein the control unit is further suited to stop the loading of the flame treatment system when the second substrate monitoring unit detects that the temperature of a substrate is too high.

12. The substrate treatment system of claim 1, wherein stopping the substrate carriers in step ii) takes place in such a way that the flame treatment system is unloaded before the substrate carriers are stopped.

13. The substrate treatment system of claim 1, wherein the substrate treatment system further comprises one or more of the following units: a paint spraying device, a cleaning device, or a coating device.

14. A method for flame treating substrates by means of the substrate treatment system of claim 1, wherein the method comprises the following steps:
continuous transport of a number of substrate carriers through the flame treatment device, wherein the substrates of each of the substrate carriers are flame treated in the flame treatment device;
monitoring the substrate carriers with respect to their transport speed and/or their dwell time in the flame zone of the flame treatment device;
monitoring the substrates with respect to their temperature after they exit the flame zone;
switching off the flame treatment device, when it is detected that a substrate carrier shows too low a transport speed and/or too long a dwell time in the flame zone; and
stopping the substrate carriers when it is detected that the temperature of a substrate is too high after it exits the flame zone.

15. The method of claim 14, wherein the method further comprises: flame measuring/flame detection in a defined area in which a substrate showing too high a temperature is stopped.

16. The method of claim 15, wherein the method further comprises: requesting a manual fire extinguishing process and/or initiating an automatic fire extinguishing process when a flame is detected.

17. The method of claim 14, wherein the method further comprises: switching off the flame treatment device when it is detected that the temperature of a substrate is too high after it exits the flame zone.

18. The method of claim 14, wherein the method further comprises: stopping the loading of the flame treatment device when it is detected that the temperature of a substrate is too high after it exits the flame zone.

19. The method of claim 14, wherein stopping the substrate carriers takes place in such a way that the flame treatment device is unloaded before the substrate carriers are stopped.

20. The method of claim 14, wherein the substrates comprise plastic.

21. The substrate treatment system of claim 3, wherein the temperature measuring unit is suited to measure the temperature of the substrates within the time period in which the substrates pass the relevant temperature measuring unit, with an accuracy of +/−10° K.
